(19) United States
(12) Patent Application Publication
(10) Pub. No.: US 2009/0255251 A1
(43) Pub. Date: Oct. 15, 2009

(54) EXHAUST GAS RECIRCULATION SYSTEM FOR AN INTERNAL COMBUSTION ENGINE

(75) Inventor: Holger Paffrath, Pulheim (DE)

Correspondence Address: DARBY & DARBY P.C., P.O. BOX 770, Church Street Station, New York, NY, 10008-0770, US

(73) Assignee: Pierburg GmbH, Neuss (DE)

(21) Appl. No.: 12/420,962

(22) Filed: Apr. 9, 2009

(30) Foreign Application Priority Data
Apr. 12, 2008 (DE) 10 2008 018 583.3

(51) Int. Cl. F02D 23/00; F02B 33/44; F02G 3/00; F02M 25/07

(52) U.S. Cl. 60/602; 60/605.2; 60/616; 123/568.12

(57) ABSTRACT

An exhaust gas recirculation system for an internal combustion engine. The system includes an exhaust gas recirculation valve disposed in an exhaust gas recirculation channel. A first exhaust gas cooler is disposed in the exhaust gas recirculation channel. A turbine is disposed in the exhaust gas recirculation channel downstream of the first exhaust gas cooler relative to a flow direction of an exhaust gas. A control valve is disposed in at least one of a region of an exhaust gas manifold and an exhaust gas channel.

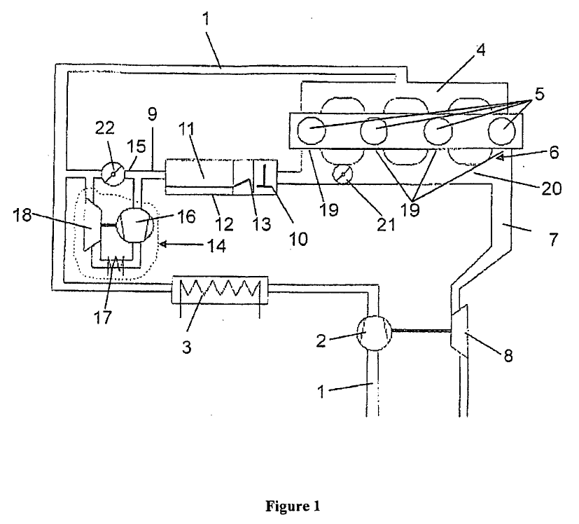

### CROSS REFERENCE TO PRIOR APPLICATIONS

Priority is claimed to German Patent Application No. DE 10 2008 018 583.3, filed Apr. 12, 2008. The entire disclosure of said application is incorporated by reference herein

### BACKGROUND

The present invention refers to an exhaust gas recirculation system for an internal combustion engine comprising an exhaust gas recirculation valve arranged in an exhaust gas recirculation channel, a first exhaust gas cooler arranged in the exhaust gas recirculation channel and a turbine in the exhaust gas recirculation channel, located downstream of the first exhaust gas cooler, when seen in the flow direction of the exhaust gas.

### FIELD

Exhaust gas recirculation systems wherein an exhaust gas cooler and an exhaust gas recirculation valve are arranged in an exhaust gas recirculation channel are generally known and are described in a number of applications. Such cooled exhaust gas recirculation systems are used especially in turbo-charged internal combustion engines. Cooling the exhaust gas results in substantial advantages with respect to emissions and the fuel consumption of a vehicle.

Systems are known in which the exhaust gas is recirculated in the high pressure zone, which means that the exhaust gas is fed back to the exhaust gas in front of the turbine and to the intake air behind the compressor; low-pressure exhaust gas recirculation systems are also known in which the exhaust gas is tapped behind the turbine and recirculated to the intake air in front of the compressor. Whereas higher exhaust gas rates are obtained with low-pressure exhaust gas recirculation systems, there is a problem of a lower pressure gradient between the exhaust gas tapping site and the site where the exhaust gas is fed into the suction channel, so that throttles have to be used in addition to augment the pressure gradient. Another advantage is the recirculation of clean exhaust gas since this may be taken behind the Diesel particulate filter in a Diesel engine, for example. In contrast herewith, a high-pressure exhaust gas recirculation system has significantly higher dynamics, however, it is limited with respect to the recirculation rates achievable, since otherwise the turbine would not be sufficient fed with exhaust gas.

Presently, cooling the exhaust gas is used in particular in low-pressure systems, however, high-pressure systems are also known that operate more dynamically and in which, after a cold start, hot exhaust gas is recirculated through the high-pressure channel. For a further enhancement of the emission and the fuel consumption characteristics, it would be feasible to cool the exhaust gas to lower temperatures than presently common and to cool it to temperatures below the prevailing coolant temperatures. Thereby, it is further possible to reduce the pinging tendency in spark-ignition engines. It is a drawback of the known systems that a high performance of the exhaust gas coolers causes the same to soot up heavily because of the low exhaust gas temperature.

EP 1,186,767 A2 describes an exhaust gas recirculation system in which a turbo cooler unit is arranged in the low-pressure zone, the unit being formed by a driven compressor, an exhaust gas cooler, and a turbine coupled with the compressor. Whereas the driven compressor allows to achieve a sufficient pressure gradient for the recirculation of exhaust gas in the low-pressure zone, the turbine causes an additional relaxation of the exhaust gas cooled in the exhaust gas cooler, which results in a further cooling of the exhaust gas, possibly below the coolant temperature. However, such a system has the disadvantage of requiring a mechanical drive of the compressor without which no sufficient pressure gradient can be built, as well as of a resulting additional energy loss of the overall system. Further, such a system does not have sufficient dynamics.

### SUMMARY

An aspect of the present invention is to provide an exhaust gas recirculation system with which exhaust gas may possibly be cooled to temperatures below the coolant temperature, the sooting and the dimensions of the exhaust gas cooler can be reduced, and exhaust gas can be recirculated with high dynamics without any loss of energy.

In an embodiment, the present invention provides for an exhaust gas recirculation system for an internal combustion engine. The system includes an exhaust gas recirculation valve disposed in an exhaust gas recirculation channel. A first exhaust gas cooler is disposed in the exhaust gas recirculation channel. A turbine is disposed in the exhaust gas recirculation channel downstream of the first exhaust gas cooler relative to a flow direction of an exhaust gas. A control valve is disposed in at least one of a region of an exhaust gas manifold and an exhaust gas channel. By providing a control valve in the exhaust gas channel, exhaust gas from one or a plurality of or all cylinders can be accumulated in the exhaust gas channel so that a sufficient pressure gradient can be available for the recirculation of exhaust gas to the suction zone of the internal combustion engine via the exhaust gas recirculation channel. The turbine behind the exhaust gas cooler may additionally cool the exhaust gas below the coolant temperature without falling below temperature within the exhaust gas cooler that would lead to an increased sooting. Such a recirculation may take place behind or in the region of the exhaust gas manifold so that the short control distance guarantees the high dynamics of the system. In such a system, the exhaust gas cooler can be more compact since an additional cooler performance is effected by the relaxation in the turbine. The turbine power thus generated can be dissipated in different ways.

### BRIEF DESCRIPTION OF THE DRAWING

The following is a detailed description of an embodiment with reference to the accompanying drawing.

The sole figure illustrates an exhaust gas recirculation system of the present invention using the example of a turbo-charged four cylinder internal combustion engine comprising a turbo cooler unit.

### DETAILED DESCRIPTION

The control valve is located, for example, in the exhaust gas manifold between the individual outlet pipes of the individual cylinders so that, with the control valve closed, only the exhaust gas from the cylinders separated by the control valve reaches the exhaust recirculation channel. Such an arrangement is advantageous in that a sufficient volume of exhaust gas is always available for a downstream turbine in the exhaust gas channel, since only the exhaust gas of individual cylinders is accumulated and is thus available for exhaust gas recirculation. Moreover, it is advantageous that only a few cylinders have to exhaust against the exhaust gas pressure possibly augmented by the cooling turbine. An additional compressor in the exhaust gas recirculation channel can be omitted so that, compared to known designs, a drive for a compressor-turbine unit can be omitted. This results in a further enhancement of the fuel consumption.

In an embodiment, the turbine may be bypassed using a bypass channel in which a second control valve is located. Thus, by leading the exhaust gas through the bypass channel, warmer exhaust gas can be recirculated to the internal combustion engine for a faster warming of the internal combustion engine, for example after a cold start.

In an embodiment, a turbo cooler unit can be provided behind the first exhaust gas cooler, this unit comprising a compressor coupled with the turbine, and a second exhaust gas cooler, where, seen in the flow direction of the exhaust gas, the compressor can be provided first downstream of the first exhaust gas cooler, followed by the second exhaust gas cooler and the turbine. In such an arrangement, the compressor need not be driven, but merely consumes the energy produced by the turbine. The use of such a turbo cooler unit increases the possibilities for a further cooling of the exhaust gas in the exhaust gas recirculation channel.

In an embodiment, the turbine can be coupled with a generator or a blower to which the turbine outputs its power. The energy balance of the internal combustion engine can thereby be further improved.

In an embodiment, the turbo cooler unit can be a structural unit so that the installation space required can be further reduced.

To improve on the dynamics of the exhaust gas recirculation system, the exhaust gas recirculation channel can branch from the exhaust gas channel before the turbine of a turbo charger and open into the suction channel of the internal combustion engine behind a charged air cooler.

Such an exhaust gas recirculation system is useful both for a further lowering of the exhaust gas temperature of the recirculated exhaust gas and for minimizing the sooting of the exhaust gas cooler. In addition, a good controllability of the system is achieved both with respect to the recirculated volume of exhaust gas and to the exhaust gas temperature. This system has high dynamics, results in a reduction of fuel consumption and in an enhancement with respect to emissions, especially to nitrogen oxides.

The internal combustion engine comprises a suction channel 1 via which fresh air can be first drawn through a compressor 2 into the suction system of the internal combustion engine. The compressed air can be guided to a suction manifold 4 via a charged air cooler 3. From the suction manifold 4, the fresh air enriched with exhaust gas reaches the cylinders 5, with the internal combustion engine of the present embodiment being a four cylinder engine. After combustion in the cylinders 5, the exhaust gas 5 produced can be expulsed into the exhaust gas manifold 6 from where the exhaust gas flows to a turbine 8 arranged in the exhaust gas channel 7 and coupled with the compressor 2 behind the turbine 8, the exhaust gas can be released into the environment.

An exhaust gas recirculation channel 9 can connect the exhaust gas manifold 4 in fluid communication with the suction channel 1 in the region behind the charged air cooler 3. For the flow control of the recirculated exhaust gas flow, an exhaust gas recirculation valve 10 can be provided in the exhaust gas recirculation channel 9. Downstream of the exhaust gas recirculation valve 10, a first exhaust gas cooler 11 can be provided for regulating the temperature of the exhaust gas. This first exhaust gas cooler 11 includes a bypass channel 12 via which the first exhaust gas cooler 11 can be bypassed. The exhaust gas flow through the first exhaust first gas cooler 11 or the bypass channel 12 can be controlled by means of a by-pass valve 13 which in the present embodiment is situated upstream of the first exhaust gas cooler 11. A system of such a design is known from prior art.

A turbo cooler unit 14 can be provided behind the first exhaust gas cooler 11, which unit can be bypassed via a bypass channel 15. In the present embodiment, the turbo cooler unit 14 is a compressor 16, a second smaller exhaust gas cooler 17 as well as a turbine 18 coupled with the compressor 16. The compressor 16 is driven only by the power outputted by the turbine.

The exhaust gas manifold 6 can be formed by four individual outlet pipes 19 terminating in a manifold pipe 20 of the exhaust gas manifold 6. According to the present invention, a control valve 21 is arranged in the manifold pipe 20, which valve separates one of the individual output pipes 29 of a cylinder 5 from the individual outlet pipes 19 of the other cylinders 5. Another control valve 22 can be provided in the bypass channel 15 to control the exhaust gas recirculation flow flowing through the bypass channel 15 or the turbo cooler unit 14.

The following is a description of the operation of the exhaust gas recirculation system using exemplary values with respect to pressure and temperature.

When the first control valve 21 in the exhaust gas manifold 6 is closed, the gas from the fourth cylinder 5 flows entirely into the exhaust gas recirculation channel 9 to the exhaust gas recirculation valve 10 via which the volume of recirculated exhaust gas is controlled according to the position of the valve. Upstream of the exhaust gas recirculation valve 10 a pressure of 4.53 bar, for example, and a temperature of 823K prevail. Via the valve, both the pressure is reduced to 4.43 bar and the temperature is lowered to approximately 733 K. With the bypass valve 13 closed, the temperature of the exhaust gas in the first exhaust gas cooler 11 is reduced, for example, to 463 K at a pressure of 4.33 bar. With the second control valve 22 closed, the exhaust gas flows via the turbo cooler unit 14. Here, the pressure of the exhaust gas is first increased to 5.2 bar in the compressor, simultaneously increasing the temperature to approximately 508 K. This temperature is then lowered to approximately 401 K in the second exhaust gas cooler 17, thereby causing a slight pressure drop to approximately 5.1 bar. Using the turbine 18 in the turbo cooler unit 14, a considerable lowering of both the pressure and the temperature is achieved by relaxation. The pressure may drop to 2.5 bar, for example, whereas the temperature can be lowered to 361 K, which is below the typical coolant temperature of an internal combustion engine. However, the pressure is still high enough for a recirculation of exhaust gas into the suction channel 1.

Without the use of the control valve 21 the pressure downstream of the turbine 18 would be insufficient, since the pressure upstream of the exhaust gas recirculation valve 10 would already be lower.

An exhaust gas recirculation system is thus provided with which the pressure level necessary to reach sufficient exhaust gas recirculation rates is guaranteed. At the same time, the temperature in the first and second exhaust gas coolers 11, 17 remains high enough to avoid significant sooting by exhaust gas that is too cold. Using the two control valves 21, 22, the system can be adjusted precisely in a simple manner both with respect to temperature and pressure, and it has high control dynamics.

The present invention is obviously not restricted to the embodiment described. For example, the first control valve 21 may be located downstream of the exhaust gas manifold 6 in the exhaust gas channel 7 to create a sufficient pressure gradient. In this case, however, all the exhaust gas would have to be exhausted on an elevated pressure level which might lead to an increase in fuel consumption.

It is further conceivable to separate more than one cylinder from the remaining exhaust gas channel using the first control valve. For example, in an internal combustion engine of the V-type, one cylinder bank could be separated from the other by means of such a control valve. When the turbo cooler unit is used in a low-pressure zone of an internal combustion engine, a sufficient pressure increase can also be achieved by means of a control valve in the exhaust gas channel, however, the control dynamics of the system would be lost with such a design.

It is noted that, with the control valve 21 and the control valve 22 open, the system operates like a conventional high-pressure exhaust gas recirculation system, where it should be observed that, when the bypass channel 15 is closed, the control valve 21 should also be closed at least partly, since otherwise no sufficient volume of exhaust gas can be recirculated.

Although the present invention has been described and illustrated with reference to specific embodiments thereof, it is not intended that the present invention be limited to those illustrative embodiments. Those skilled in that art will recognize that variations and modifications can be made without departing from the true scope of the present invention as defined by the claims that follow. It is therefore intended to include within the present invention all such variations and modifications as fall within the scope of the appended claims and equivalents thereof.

What is claimed is:

1. An exhaust gas recirculation system for an internal combustion engine, the system comprising:
an exhaust gas recirculation valve disposed in an exhaust gas recirculation channel;
a first exhaust gas cooler disposed in the exhaust gas recirculation channel;
a turbine disposed in the exhaust gas recirculation channel downstream of the first exhaust gas cooler relative to a flow direction of an exhaust gas; and
a control valve disposed in at least one of a region of an exhaust gas manifold and an exhaust gas channel.

2. The system recited in claim 1, wherein the control valve is disposed in the exhaust gas manifold between individual outlet pipes of individual cylinders of the engine so that, with the control valve closed, only the exhaust gas from the cylinders separated by the control valve reaches the exhaust gas recirculation channel.

3. The system recited in claim 1, further comprising a second control valve disposed in a bypass channel for bypassing the turbine.

4. The system recited in claim 1, wherein the turbine is part of a turbo cooler unit, wherein the turbo cooler unit includes a compressor, the turbine and a second exhaust gas cooler, the compressor being the first element downstream of the first exhaust gas cooler, followed by the second exhaust gas cooler and the turbine, relative to the direction of the exhaust gas flow.

5. The system recited in claim 4, further comprising a bypass channel, wherein the turbo cooler unit can be bypassed using the bypass channel in which the second control valve is configured.

6. The system recited in claim 1, further comprising at least one of a generator and a blower coupled to the turbine, the turbine outputting its power to the generator or blower.

7. The system recited in claim 4, wherein the turbo cooler unit includes the compressor, turbine and second exhaust cooler integrally formed as a structural unit.

8. The system recited in claim 1, wherein the exhaust gas recirculation channel branches from the exhaust gas channel upstream from a turbine of a turbo charger disposed in the exhaust gas channel and terminates in a suction channel of the internal combustion engine downstream of a charged air cooler.
